(19) United States
(12) Patent Application Publication
(10) Pub. No.: US 2022/0041225 A1
(43) Pub. Date: Feb. 10, 2022

(54) FLOOR-CROSSMEMBER COMBINATION

(71) Applicant: Clifford O. McWilliams, Owasso, OK (US)

(72) Inventor: Clifford O. McWilliams, Owasso, OK (US)

(21) Appl. No.: 17/396,930

(22) Filed: Aug. 9, 2021

Related U.S. Application Data
(60) Provisional application No. 63/063,551, filed on Aug. 10, 2020.

(51) Int. Cl. B62D 25/20

(52) U.S. Cl. CPC B62D 25/20

(57) ABSTRACT

A floor-crossmember combination to be used in forming a dump trailer floor without the use of floor panels. Each floor-crossmember combination may have at least one elongate arm terminating in a projection and a corresponding slot, allowing adjacent floor-crossmember combinations to be connected together via the projection of one and slot of the other, then welded together.

### CROSS REFERENCE

This application is based on and claims priority to U.S. Provisional Patent Application No. 63/063,551, filed Aug. 10, 2020, which is incorporated herein in its entirety by reference.

### BACKGROUND OF THE INVENTION

### Field of the Invention

This invention relates generally to a floor-crossmember combination, and more particularly, but not by way of limitation, to an improved dump trailer floor constructed from unique crossmembers without separate floor panels.

### Description of the Related Art

Dump trailers are currently constructed with a floor made of floor panels with reinforcing crossmembers. The floor panels are welded together, with crossmembers welded underneath for support.

Materials and labor are the primary expenses in the construction of dump trailers. Thus, reducing necessary material and simplifying the process would reduce the cost of constructing a dump trailer, allowing higher profits and/or lower prices for the dump trailers.

Other trailers, vehicles, containers, and/or other structures may benefit from the same improved floor construction.

Based on the foregoing, it is desirable to provide an improved dump trailer floor construction that reduces necessary materials.

It is further desirable for the improved dump trailer floor to be easy to construct.

It is further desirable for the floor construction to be applicable to other types of trailers and/or other vehicles and structures.

### SUMMARY OF THE INVENTION

In general, in a first aspect, the invention relates to a floor comprising a plurality of floor-crossmember combinations. Each floor-crossmember combination may be elongate and may comprise a vertical body with a top and a bottom; an arm extending perpendicularly from the top of the vertical body, where the arm has a distal edge forming a downward-pointing projection; and an upward-facing slot. The slot may be located at the top of the vertical body or at the distal edge of a second opposing arm extending perpendicularly from the top of the vertical body. The projection of one of the floor-crossmember combinations may be receivable in the slot of another of the floor-crossmember combinations such that the arms of both floor-crossmember combinations form a planar surface.

Each of the floor-crossmember combinations may further comprise a perpendicular foot projecting right and left from the bottom of the vertical body. Adjacent floor-crossmember combinations may be welded together. The floor may not comprise floor panels. The arm of each floor-crossmember combination may have a width greater than the height of the perpendicular body. The floor may be a dump trailer floor.

In a second aspect, the invention relates to a floor-crossmember combination for use in a trailer floor, where the floor-crossmember combination is elongate and comprises: a vertical body with a top and a bottom; an arm extending perpendicularly from the top of the vertical body, where the arm has a distal edge forming a downward-pointing projection; and an upward-facing slot, where the projection of one of the floor-crossmember combinations is receivable in the slot of another of the floor-crossmember combinations such that the arms of both floor-crossmember combinations form a planar surface. The slot may be located at the top of the vertical body or at the distal edge of a second opposing arm extending perpendicularly from the top of the vertical body.

The floor-crossmember combination may further comprise a perpendicular foot projecting right and left from the bottom of the vertical body. The arm may have a width greater than the height of the perpendicular body.

In a third aspect, the invention relates to a method of constructing a floor using a plurality of floor-crossmember combinations. Each floor-crossmember combination may comprise: a vertical body with a top and a bottom; an arm extending perpendicularly from the top of the vertical body, where the arm has a distal edge forming a downward-pointing projection; and an upward-facing slot, where the projection of one of the floor-crossmember combinations is receivable in the slot of another of the floor-crossmember combinations such that the arms of both floor-crossmember combinations form a planar surface. The slot may be located at the top of the vertical body or at the distal edge of a second opposing arm extending perpendicularly from the top of the vertical body. The method may comprise: laying a first floor-crossmember combination upside down on a surface; placing the slot of a second floor-crossmember combination onto the projection of the first floor-crossmember combination; rotating the second floor-crossmember combination to align the arms into a single plane; repeating the placing and rotating steps with additional floor-crossmember combinations; welding the floor-crossmember combinations together; and flipping the floor-crossmember combinations right-side-up. The method may further comprise welding the seams between the floor-crossmember combinations to form a unitary floor.

### BRIEF DESCRIPTION OF THE DRAWINGS

FIG. 1 is a side view of a floor created using the floor-crossmember combination of the present invention;

FIG. 2 is a side view of a single unit of the floor-crossmember combination;

FIG. 3 is a partial side view of two units of the floor-crossmember combination being joined together;

FIG. 4 is a side view of a floor created using an alternate configuration of the floor-crossmember combination of the present invention; and

FIG. 5 is a side view of a single unit of the alternate configuration of the floor-crossmember combination.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a floor-cross member combination 1 for dump trailers. The floor-crossmember combination 1 may also be used in other types of trailers, other vehicles, other containers, etc. Multiple units of the floor-crossmember combination 1 may be assembled into a reinforced floor without the use of floor panels.

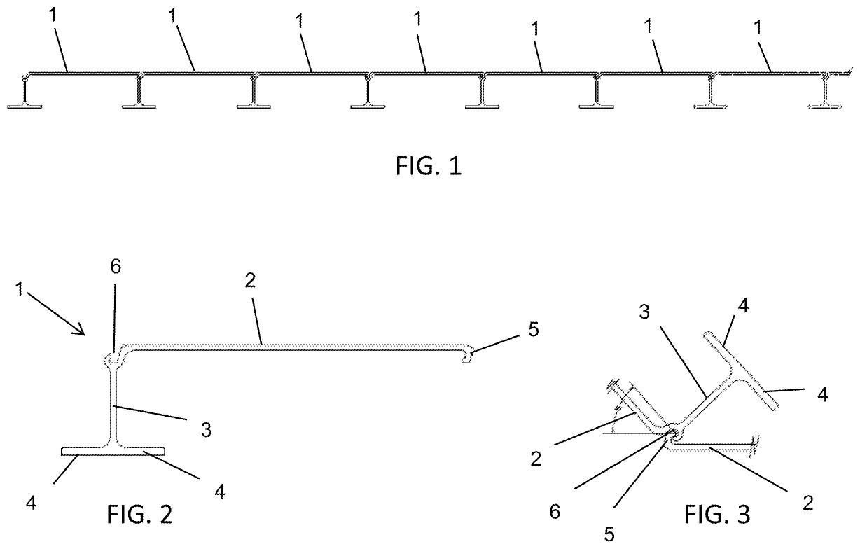

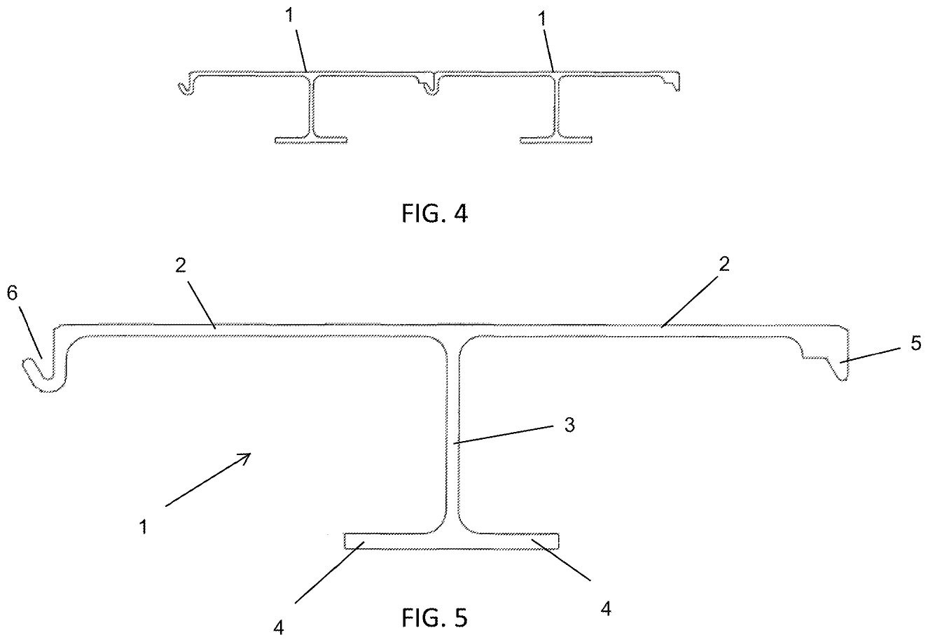

Each floor-crossmember combination 1 may be similar to a typical crossmember, but with at least one elongated arm 2. Specifically, each floor-crossmember combination 1 may have one elongated arm 2, as shown in FIGS. 1 through 3, or two elongated arms 2, as shown in FIGS. 4 and 5. Each floor-crossmember combination 1 may be elongate and may have a cross section as shown in FIG. 2 or FIG. 5. The floor-crossmember combination 1 may have a vertical central body 3 and perpendicular feet 4 extending to either side at the bottom of the vertical central body 3. The elongated arm 2 may extend perpendicularly from one side of the top of the vertical central body 3, as shown in FIGS. 1 through 3, or two sides of the top of the vertical central body 3, as shown in FIGS. 4 and 5. The distal end of one elongated arm 2 may terminate in a downward-pointing projection 5. A corresponding slot 6 may be located at the top of the vertical central body 3, as shown in FIGS. 1 through 3, or at the end of the other elongated arm 2, as shown in FIGS. 4 and 5, allowing adjacent units of the floor-crossmember combination 1 to attach together.

During assembly, a single unit of the floor-crossmember combination 1 may be placed upside down on a surface. A second unit of the floor-crossmember combination 1 may be attached thereto by placing the slot 6 of the second unit onto the projection 5 of the first unit, as shown in FIG. 3, and then rotated to align the elongated arms 2 into a single plane. Additional units of the floor-crossmember combination 1 may be added in the same manor. The user may weld or otherwise secure the units of the floor-crossmember combination 1 together, allowing the user to flip the floor-crossmember combinations 1 right-side-up. The user may then weld along the seams between the individual floor-crossmember combination 1 units, if desired. If the tops of the seams are to be welded, the bottoms may only be spot welded. The locking design of the floor-crossmembers combinations 1 may allow for weldability with high magnesium content extrusions and/or high yield aluminum. Whether the tops of the seams are welded or only the bottoms are welded, the floor-crossmember combinations 1 may form a unitary floor 7, with the central vertical bodies 3 and feet 4 extending downward, reinforcing the floor 7.

The floor 7 may be formed solely from the floor-crossmember combinations 1, welded together, without the use of floor panels. The floor 7 may thus require less materials than a typical dump trailer floor, and may be capable of being assembled by a single person. The floor 7 may thus cost less to assemble, in both materials and labor, than a typical dump trailer floor.

Whereas, the devices and methods have been described in relation to the drawings and claims, it should be understood that other and further modifications, apart from those shown or suggested herein, may be made within the spirit and scope of this invention.

What is claimed is:

1. A floor comprising a plurality of floor-crossmember combinations, where each floor-crossmember combination is elongate and comprises:
a vertical body with a top and a bottom;
an arm extending perpendicularly from the top of the vertical body, where the arm has a distal edge forming a downward-pointing projection; and
an upward-facing slot, where the downward-pointing projection of one of the floor-crossmember combinations is receivable in the upward-facing slot of another of the floor-crossmember combinations such that the arms of both floor-crossmember combinations form a planar surface.

2. The floor of claim 1 where the upward-facing slot is located at the top of the vertical body.

3. The floor of claim 1 where the upward-facing slot is located at a distal edge of an opposing second arm extending perpendicularly from the top of the vertical body.

4. The floor of claim 1 where each of the floor-crossmember combinations further comprises a perpendicular foot projecting right and left from the bottom of the vertical body.

5. The floor of claim 1 where adjacent floor-crossmember combinations are welded together.

6. The floor of claim 1 not comprising floor panels.

7. The floor of claim 1 where the arm of each floor-crossmember combination has a width greater than the height of the perpendicular body.

8. The floor of claim 1 where the floor is a dump trailer floor.

9. A floor-crossmember combination for use in a trailer floor, where the floor-crossmember combination is elongate and comprises:
a vertical body with a top and a bottom;
an arm extending perpendicularly from the top of the vertical body, where the arm has a distal edge forming a downward-pointing projection; and
an upward-facing slot, where the downward-pointing projection of one of the floor-crossmember combinations is receivable in the upward-facing slot of another of the floor-crossmember combinations such that the arms of both floor-crossmember combinations form a planar surface.

10. The floor-crossmember combination of claim 9 where the upward-facing slot is located at the top of the vertical body.

11. The floor-crossmember combination of claim 9 where the upward-facing slot is located at a distal edge of an opposing second arm extending perpendicularly from the top of the vertical body.

12. The floor-crossmember combination of claim 9 further comprising a perpendicular foot projecting right and left from the bottom of the vertical body.

13. The floor-crossmember combination of claim 9 where the arm has a width greater than the height of the perpendicular body.

14. A method of constructing a floor using a plurality of floor-crossmember combinations, each floor-crossmember combination comprising:
a vertical body with a top and a bottom;
an arm extending perpendicularly from the top of the vertical body, where the arm has a distal edge forming a downward-pointing projection; and
an upward-facing slot, where the downward-pointing projection of one of the floor-crossmember combinations is receivable in the upward-facing slot of another of the floor-crossmember combinations such that the arms of both floor-crossmember combinations form a planar surface;
the method comprising:
laying a first floor-crossmember combination upside down on a surface;
placing the slot of a second floor-crossmember combination onto the projection of the first floor-crossmember combination;
rotating the second floor-crossmember combination to align the arms into a single plane;
repeating the placing and rotating steps with additional floor-crossmember combinations;
welding the floor-crossmember combinations together; and
flipping the floor-crossmember combinations right-side-up.

15. The method of constructing a floor of claim 14, the method further comprising welding the seams between the floor-crossmember combinations to form a unitary floor.

16. The method of constructing a floor of claim 14 where the upward-facing slot is located at the top of the vertical body.

17. The method of constructing a floor of claim 14 where the upward-facing slot is located at a distal edge of an opposing second arm extending perpendicularly from the top of the vertical body.
